(19) United States
(12) Patent Application Publication
(10) Pub. No.: US 2006/0005718 A1
(43) Pub. Date: Jan. 12, 2006

(54) Method for marking golf ball and golf ball

(75) Inventor: Takashi Ohira, Chichibu-shi (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: BRIDGESTONE SPORTS CO., LTD.

(21) Appl. No.: 10/886,044

(22) Filed: Jul. 8, 2004

(51) Int. Cl. B41F 17/30

(52) U.S. Cl. 101/34; 101/35

(57) ABSTRACT

The invention discloses a method for marking indicia such as letters and patterns on a golf ball surface. The method is characterized by computer-generating a reverse image of the indicia, printing the reverse image as a reverse toner image onto a transfer substrate with a laser printer, and placing the reverse toner image-bearing transfer substrate against the golf ball surface under applied heat and pressure so as to form a positive toner image on the surface of the ball. This method simplifies and facilitates the marking operation, in addition to which it enables a reverse toner image to be reliably printed onto a transfer sheet and enables indicia to be accurately formed on the surface of the ball.

### BACKGROUND OF THE INVENTION

The present invention relates to a golf ball marking method for forming indicia, such as markings, numbers, the player's name and patterns, on the surface of a golf ball using a laser printer, and to golf balls obtained using such a method. More specifically, the invention relates to a golf ball marking method which involves fewer operations and is easier to carry out, and to golf balls obtained thereby.

Golf balls are generally marked by directly or indirectly printing letters, numbers, trade names and patterns such as logos on the ball's surface. Marking methods used include stamp printing, pad printing, transfer-tape printing, inkjet printing, and printing with an electrostatic copier.

Stamp printing has high operational costs because most of the metal foil is discarded without being used. Pad printing can be carried out at a relatively low cost using an image plate made of photosensitive resin, although the creation of a large number of impressions requires the use of a metal plate, which is expensive. Moreover, because the same number of printing heads is required as the number of colors used, this process is difficult to adapt to multicolor marking. Transfer-tape printing is costly because it requires the fabrication of a transfer tape and the production of an image plate. Inkjet printing uses an ink containing a solvent of low volatility, and so the underlying surface must be hygroscopic, which makes it difficult to achieve water resistance. In inkjet printing, dyes are most often used as the colorants, resulting in a poor weather resistance. Sometimes pigments are used as the colorant, but because pigments of a small particle size must be employed in such cases, a fully satisfactory weather resistance has yet to be achieved.

Printing with an electrostatic copier does not require the production of an image plate, is inexpensive, and is readily conducive to multicolor printing and design changes. This process is thus suitable for printing golf balls in small lots. One example of such a method, disclosed in JP 3036488, involves forming a toner image on the surface of a release sheet, then placing a transfer sheet over the toner image-bearing side of the release sheet and pressing them together so as to transfer a reverse toner image onto the transfer sheet. The transfer sheet is then placed against the golf ball surface under applied heat and pressure, thereby transferring the toner image on the transfer sheet to the surface of the ball.

However, in this printing process involving the use of an electrostatic copier, before the toner image on the transfer sheet can be transferred to the golf ball surface, a transfer sheet having the reverse toner image must be obtained. This requires a step in which the reverse toner image is transferred from the release sheet. Hence, the overall marking operation involves a larger number of steps, and is thus more labor intensive and complicated.

### SUMMARY OF THE INVENTION

Therefore, one object of the present invention is to provide a marking method which reduces the number of steps involved in forming indicia on the surface of golf balls and makes the overall operation easier to carry out. Another object of the invention is to provide golf balls obtained using such a method.

The inventors have conducted extensive investigations in order to achieve the above objects. As a result, they have discovered that, in a golf ball marking method in which indicia such as letters and images are formed on the surface of a golf ball, by computer-generating a reverse image of the indicia, printing the reverse image as a reverse toner image on a transfer substrate with a laser printer, and placing the reverse toner image-bearing transfer substrate against the golf ball surface under applied heat and pressure so as to form a positive toner image on the surface of the ball, the step of transferring a reverse toner image to the transfer sheet that has been carried out in the prior art can be eliminated, thus simplifying and facilitating the marking operation. This discovery ultimately led to the present invention.

Accordingly, the invention provides the following golf ball marking method and golf ball.
(1) A method for marking indicia such as letters and patterns on a golf ball surface, the method being characterized by computer-generating a reverse image of the indicia, printing the reverse image as a reverse toner image onto a transfer substrate with a laser printer, and placing the reverse toner image-bearing transfer substrate against the golf ball surface under applied heat and pressure so as to form a positive toner image on the surface of the ball.
(2) The golf ball marking method of claim 1, wherein the transfer substrate is a single-ply sheet made of polyethylene terephthalate or a laminated sheet having a glassine paper base.
(3) The golf ball marking method of claim 1, wherein a hot-melt resin is coated onto a surface of the transfer substrate so as to cover the reverse toner image that has been printed onto the transfer substrate, following which the transfer substrate is placed against the golf ball surface under applied heat and pressure so as to form a positive toner image.
(4) The golf ball marking method of claim 1, wherein the toner used in the image printing device is an encapsulated polymerization toner.
(5) A golf ball which is characterized in that predetermined indicia have been formed on a surface thereof by the marking method of any one of claims 1 to 4.

### BRIEF DESCRIPTION OF THE DIAGRAMS

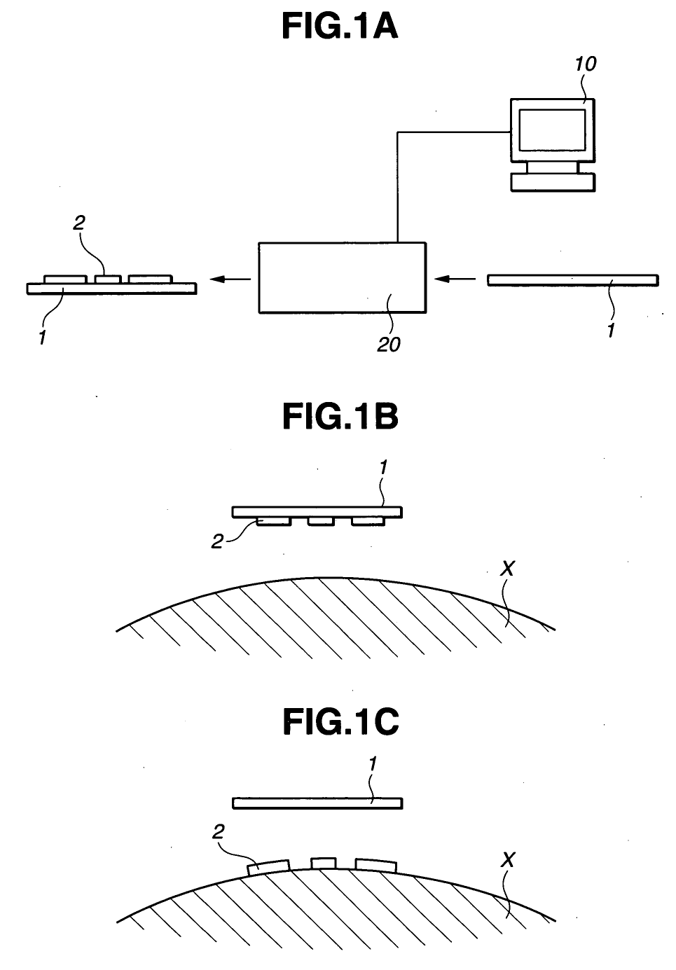

FIG. 1 illustrates a method for marking golf balls according to one embodiment of the invention.

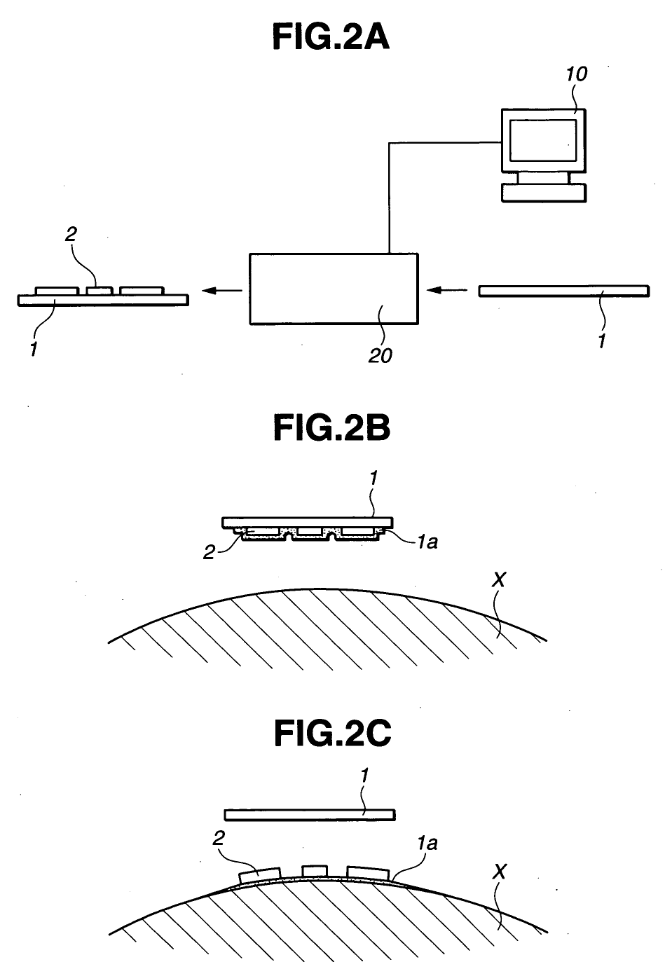

FIG. 2 illustrates a method for marking golf balls according to another embodiment of the invention.

### DETAILED DESCRIPTION OF THE INVENTION

The mode of working the invention and embodiments thereof are described below while referring to FIGS. 1 and 2. In the diagrams, (A) to (C) illustrate the inventive method for marking golf balls. This is a marking method in which indicia such as letters and patterns are formed on the surface of a golf ball.

In the inventive method, the first step is to generate a reverse image of the labeling element using a computer 10. More specifically, although not shown in the diagrams, desired indicia can be generated using an image-generating means (software) in a computer 10. In addition to an image-generating means, the computer 10 includes components such as a central processing unit (CPU) and memory. The image-generating means works together with hardware such as the CPU and the memory to implement the function of the image-generating means.

The second step is to print the above reverse image on a transfer substrate with an image printing device. As shown in FIG. 1(A), image data for the reverse image obtained in the first step is transmitted to an image printing device 20 which prints a desired toner image 2 on a transfer substrate 1 based on the image data.

The image-recording device 20 is connected to the computer 10. A laser printer is used as the image-recording device 20.

The image-printing device 20 generally is provided with a step in which a transfer substrate 1 to which toner has been transferred from a drum is passed between a pair of fixing rollers, thereby fixing the toner image 2 to the transfer substrate 1.

A transfer substrate 1 of sufficient hardness to be able to pass through the image-printing device 20 is used in the practice of the invention. For example, use may be made of a substrate which is a single-ply sheet made of polypropylene, polyethylene terephthalate, soft polyvinyl chloride, polyethylene, polytetrafluoroethylene, silicone rubber, kraft paper, glassine paper or some other material or is a laminated sheet, onto one side of which substrate has been applied a resin-based pressure-sensitive adhesive such as one made of an acrylic or vinyl acetate-based resin, or a synthetic rubber-based pressure-sensitive adhesive. Because it is necessary to confer the substrate with flexibility so that the toner image reliably adheres to the dimpled, uneven surface on which the indicia are to be formed and it is also necessary for the substrate to be resistant to deformation by heat, the use of a laminated sheet which includes glassine paper is especially preferred. If the substrate is a single-ply sheet, the use of polyethylene terephthalate having a side that has been treated with a parting agent is preferred.

Sometimes such a transfer substrate does not fit tightly against and adhere well to the dimpled, uneven golf ball surface on which the indicia are to be formed, so that slight gaps between the toner image and the golf ball surface where indicia are to be formed inevitably arise in some places. As a result, adherence by the toner image to the indicia-forming surface on the golf ball may be inadequate. This problem can be alleviated by making the pad surface used to press the toner image against the ball surface from the back side of the transfer substrate of a material that is heat resistant and flexible, such as silicone rubber, and that has a thickness of 1 to 20 mm, and preferably 1 to 8 mm.

When the subsequently described transfer substrate 1 is placed against the golf ball surface under applied heat and pressure, a bond strength sufficient for transferring toner image 2 to the golf ball surface X is required. For this reason, a hot-melt resin 1a may be applied to the toner image 2 forming site on the printing side of the transfer substrate 1 (see FIG. 2). A hot-melt resin is especially desirable for facilitating transfer at a low temperature.

Hot-melt resins that may be used include known resin materials, such as EVA, polyolefin, polyester, polyamide and urethane-based resins. For example, use can be made of the polyolefin-based resin produced by Nippon Paper Chemicals Co., Ltd. under the trade name Auroren 150.

It is advantageous to select a toner material capable of exhibiting the adhesive properties of the toner at a transfer temperature within a range of 100 to 200° C., and especially 140 to 190° C. Using a toner that exhibits adhesive properties at a temperature lower than the above range may result in separation of part of the toner image from the ball's surface following transfer. On the other hand, when a toner that exhibits adhesive properties at a temperature higher than the above range is used, the temperature must be set to a value higher than the above range in order for transfer to occur. The intense heat in such cases may damage the surface of the golf ball.

The toner used in the toner image 2 may be one made of a known material. An encapsulated polymerization toner is especially preferred. The use of a toner of this type enables the toner image to be fixed at a low temperature.

The third step in the inventive method is to place the above-described transfer substrate bearing a reverse toner image against the golf ball surface under applied heat and pressure. As shown in FIGS. 1B and 1C, by placing a transfer substrate 1 bearing a reverse toner image 2 against a golf ball surface X under applied heat and pressure, a positive toner image 2 is formed at the surface X, thereby marking the ball with the predetermined indicia.

If a hot-melt resin 1a is coated onto the surface of the transfer substrate so as to cover the reverse toner image that has been printed thereon, as shown in FIGS. 2B and 2C, when the transfer substrate 1 is placed against the golf ball surface X and subjected to applied heat and pressure, the hot-melt resin 1a laminates onto the ball surface X and the toner image 2 forms on top thereof.

The material of which the golf ball surface X where the indicia are formed is not subject to any particular limitation. For example, a golf ball cover is typically made of an ionomer resin, a urethane resin, a polyester resin, or a mixture of a polyurethane resin and a polyester resin, and the protective coat serving as the outermost layer is typically formed with a two-part curable urethane coating (obtained by a crosslinking reaction between a polyol such as acrylic polyol, polyester polyol or polycarbonate polyol and an isocyanate), an aqueous emulsion coating (e.g., a polyester-based urethane resin coating) or a UV-curable acrylic coating. Good indicia can be formed by the inventive method on the surface of a layer made of any of these materials. It is especially preferable for the surface on which the indicia are formed to be the surface of a layer composed of a urethane material. A layer of this type is flexible and has stretch, preventing damage to the transferred toner image such as from fissuring when the ball is hit.

A preferred example of the pressing member (not shown) used for applying heat and pressure is a rubber pad which is made of silicone rubber and has a rubber hardness (JIS-A) of 20 to 60, preferably 35 to 45, and a thickness of 1 to 20 mm, preferably 1 to 8 mm. With such a pad, the toner image 2 on the surface X where the indicia are formed can be given an even better appearance. If the pressuring member is too hard or too thin, deformation or heat distortion may arise due to slippage of the toner image 2. It is suitable for the temperature at the pad surface during pressing to be from 100 to 230° C., and especially 130 to 200° C., and for the period of heat and pressure application to be from 0.1 to 10 seconds, and especially 0.5 to 1.5 seconds. When a hot-melt resin 1a is used, a temperature of 100 to 150° C. is especially preferred. After the toner image 2 has been transferred to the surface X where the indicia are to be formed, this surface X may also be heated to better fix the toner image 2.

More specifically, for thermal transfer to a golf ball surface made of an ionomer resin, a temperature within a range of 130 to 170° C. is preferred. For thermal transfer to a golf ball surface made of urethane resin, a temperature within a range of 150 to 200° C. is preferred.

The thickness of the indicia (toner image 2) in the invention can be adjusted such as to be about 1 to 8 μm after transfer to the ball. Toner particles of a small size provide indicia of a better image quality and a greater durability.

In the practice of the invention, to improve fixing and adhesion of the toner image 2 to the surface X where the indicia are to be formed, physical or chemical surface treatment such as surface roughening treatment or surface modifying treatment may be administered to that portion of the golf ball surface prior to transfer of the toner image. Specific examples of such surface treatment include plasma treatment, corona discharge treatment, UV irradiation treatment, chlorine treatment, primer coating treatment, treatment that involves wiping the surface with an organic solvent, treatment involving the application of a silane coupling agent, honing treatment, and physical surface roughening treatment.

No particular limitation is imposed on the construction, materials or method of manufacturing the golf ball to be obtained by the inventive marking method. That is, the ball can be formed by a conventional method using a known material. As for the ball construction, the ball may be a thread-wound golf ball or may be a solid golf ball having a one-piece construction, a two-piece construction, or a multi-piece construction that includes two or more cover layers.

After the toner image 2 has been transferred to the golf ball surface X, it may be advantageous to apply a clear coating to the surface of the ball as an outermost protective coat so as to protect the indicia. Alternatively, in cases where the toner image is transferred to the surface of an outermost protective coat of the golf ball, it is desirable to form a clear film over the toner image following removal of the transfer sheet. Doing so helps to protect the indicia. Any suitable coating may be used for clear coating in the former case or to form a clear film in the latter case. Exemplary coatings include two-part curable urethane coatings, aqueous emulsion coatings and UV-curable acrylic coatings. Urethane coatings are especially preferred. Depending on the solvent used in the coating, the solvent may dissolve the toner. It is thus suitable to employ a coating which uses a solvent that does not dissolve the toner or a coating which uses a solvent that dissolves the toner without allowing it to run. In particular, when a coating which uses a solvent that dissolves the toner without allowing it to run is employed, by impregnating the solvent in the toner image so as to slightly dissolve the toner, adhesion between the toner image and the surface where the indicia are formed can be enhanced. When the toner is an epoxy-based toner, the solvent that dissolves the toner without allowing it to run is exemplified by solvents composed primarily of xylene. Coatings in which the solvent is primarily xylene have a relatively long drying time, and thus can be easily and conveniently applied with a brush. For styrene-based toners, the use of an alcohol-based solvent is preferred.

As explained above, the golf ball marking method of the invention eliminates the specific step in which a transfer sheet is pressed against a toner image on a release sheet so as to transfer a reverse toner image to the transfer sheet. Accordingly, the inventive method simplifies and facilitates the golf ball marking operation. Moreover, by reliably printing the reverse toner image onto the transfer sheet, indicia can be reliably formed as positive images on the golf ball surface. Also, there is no need to produce an image plate, thus lowering costs, in addition to which multicolor printing and design changes can easily be carried out, making this marking method optimal for printing on golf balls in small lots.

### EXAMPLE

Examples are give below by way of illustration and not by way of limitation.

A reverse image of given indicia was created with imaging software on a personal computer 10. The image data was sent to a printer 20 connected to the personal computer 10, and printed on a transfer substrate. The transfer substrate 1 (referred to hereinafter as “transfer film 1”) was a polyethylene terephthalate film which had a base film thickness of 30 μm and a release-treated side. A styrene-based toner was used.

Next, golf balls for the transfer thereon of the markings were prepared. These were two-piece balls constructed of a crosslinked rubber core of primarily polybutadiene rubber enclosed by a 2 mm thick cover material made primarily of thermoplastic polyurethane elastomer having a Shore D hardness of 45 or a 2 mm thick cover material made primarily of an ionomer resin having a Shore D hardness of 65. The surface of these balls was plasma treated. As shown in FIGS. 1C and 2C, a transfer film 1 was placed against the surface X of the golf ball under applied heat and pressure for 1 second according to the respective conditions for each example, thereby forming a given positive toner image 2 on golf ball surface X, with or without an intervening hot-melt resin 1a. In cases where there was no intervening hot-melt resin 1a, a toner image was formed on the surface of the golf ball by the sequence of steps shown in FIG. 1. In cases where there was an intervening hot-melt resin 1a, a toner image was formed on the surface of the golf ball by the sequence of steps shown in FIG. 2.

The balls marked by the method followed in each example were then evaluated. The results are shown below.

TABLE 1

| | Example 1 | Example 2 | Example 3 |
|---|---|---|---|
| Ball surface material | urethane | ionomer | ionomer |
| | resin | resin | resin |
| Transfer temperature | 180° C. | 160° C. | 140° C. |
| (° C.) | | | |
| Hot melt application | no | no | yes |
| Process diagram | | | |
| External heat damage | none | none | none |
| Transferability | excellent | excellent | excellent |

Notes:
Urethane resin: Produced by DIC Bayer Polymer Ltd. under the trade name Pandex T8295.
Ionomer resin: Produced by DuPont-Mitsui Polychemicals Co., Ltd. under the trade name Himilan 1605.
Hot-melt resin: Produced by Nippon Paper Chemicals Co., Ltd. under the trade name Auroren 150 (7% toluene solution; softening temperature, 105 to 135° C.).

1. A method for marking indicia such as letters and patterns on a golf ball surface, the method comprising:
computer-generating a reverse image of the indicia;
printing the reverse image as a reverse toner image onto a transfer substrate with a laser printer; and
placing the reverse toner image-bearing transfer substrate against the golf ball surface under applied heat and pressure so as to form a positive toner image on the surface of the ball,
wherein the toner used in said image printing device is an encapsulated polymerization toner.

2. The golf ball marking method of claim 1, wherein said transfer substrate is a single-ply sheet made of polyethylene terephthalate or a laminated sheet having a glassine paper base.

3. The golf ball marking method of claim 1, wherein a hot-melt resin is coated onto a surface of the transfer substrate so as to cover the reverse toner image that has been printed onto the transfer substrate, following which the transfer substrate is placed against the golf ball surface under applied heat and pressure so as to form a positive toner image.

4. (canceled)

5. A golf ball which is characterized in that predetermined indicia have been formed on a surface thereof by the marking method of claim 1.
